(19) United States
(12) Patent Application Publication
(10) Pub. No.: US 2013/0186182 A1
(43) Pub. Date: Jul. 25, 2013

(54) LEAK INSPECTION DEVICE AND LEAK INSPECTION METHOD

(71) Applicant: Tetsuya Yamaguchi, Nagoya-shi (JP)

(72) Inventor: Tetsuya Yamaguchi, Nagoya-shi (JP)

(73) Assignee: TOYOTA JIDOSHA KABUSHIKI KAISHA, Toyota-shi (JP)

(21) Appl. No.: 13/876,744

(22) PCT Filed: Sep. 27, 2011
(86) PCT No.: PCT/JP2011/072019

§ 371 Date: Mar. 28, 2013

(30) Foreign Application Priority Data
Sep. 30, 2010 (JP) 2010-220951

(51) Int. Cl. G01M 3/26

(52) U.S. Cl. CPC G01M 3/26
USPC 73/49.2

(57) ABSTRACT

A leak inspection device for inspecting leaks from a work by sealing a gas inside the work or sucking the gas therefrom includes: a depressurizing device that reduces the pressure of the gas inside the work; a pressurizing device that pressurizes the gas inside the work; a temperature sensor that detects the temperature of the work; a pressure sensor that detects the pressure of the gas inside the work; and a controller. The controller calculates the saturation vapor pressure at the same temperature as the temperature of the work, controls the depressurizing device to thereby reduce the pressure of the gas inside the work to the saturation vapor pressure, sucks the water vapor that has vaporized inside the work, controls the pressurizing device to thereby seal the gas inside the work and pressurize the gas inside the work until the temperature of the work detected by the temperature sensor reaches a predetermined temperature.

### TECHNICAL FIELD

The present invention relates to a leak inspection device and a leak inspection method.

### BACKGROUND ART

It is conventionally known that gas is enclosed in a work to be inspected to inspect the leak from the work. For example, in the automobile factory, the leak inspections are operated to various manufactures such as an engine cylinder block.

JP S60-111249 U discloses the leak inspection method that includes pressurizing the master chamber and the work at the same time, and detecting the differential pressure between the master chamber and the work. The internal pressure of the work is influenced by the temperature variation of the work and environment thereof or by the water remained inside the work. JP S60-111249 U may fail to deal with these disturbances, so that it is difficult to put into practice.

JP 2007-218745 A discloses the leak inspection method adjusting the amount of the water remained in the work by means of a heat source. Heating up the work to completely vaporize the water remained in the work requires huge amount of heat. Such heat source may be too large to be useful in the mass-produce lines. It may take long time to cool down the heated-up work to be handled without considering the heat exchange with surroundings. It is also difficult to employ such long time cooling section in the mass-produce lines.

JP 2006-275906 A discloses the leak inspection method detecting the leak amount momentarily by measuring the change of the pressure by pressure sensor with a special pressurizing/depressurizing cycle. JP 2006-275906 A cannot be applicable to the work with large capacity such as the cylinder block. The water remained in the work, which is one of the disturbances, is not considered, so that it is difficult to put into practice.

As described above, conventional leak inspection methods may fail to deal with the disturbances including the temperature variation of the work or the water remained in the work. Therefore, the reliable leak inspection has not been obtained.

### Citation List

### Patent Literature

PTL 1: JP S60-111249 U

PTL 2: JP 2007-218745 A

PTL 3: JP 2006-275906 A

### SUMMARY OF INVENTION

### Technical Problem

The objective of the present invention is to provide a technique of removing the disturbances on the leak inspection such as the temperature variation and the water remained in the work.

### Technical Solutions

The first embodiment of the present invention is a leak inspection device for inspecting a leak from a work, which includes: a depressurizing device for depressurizing a gas in the work; a pressurizing device for pressurizing the gas in the work; a temperature sensor for measuring the temperature of the work; a pressure sensor for measuring the internal pressure of the work; and a controller for controlling the pressure of the gas in the work by means of the depressurizing device and the pressurizing device. The controller calculates a saturation vapor pressure at the work temperature measured by the temperature sensor, the depressurizing device evacuates the gas in the work until the internal pressure of the work reaches the saturation vapor pressure and sucks the vaporized water, and the pressurizing device pressurizes the gas in the work until the temperature of the work reaches a predetermined temperature.

The second embodiment of the present invention is a leak inspection method for inspecting a leak from a work, which includes: depressurizing process for depressurizing a gas in the work until the internal pressure of the work reaches a saturation vapor pressure at the work temperature and sucking the vaporized water; and pressurizing process for pressurizing the gas in the work until the temperature of the work reaches a predetermined temperature.

### Advantageous Effects of Invention

According to the present invention, the disturbances on the leak inspection can be removed such as the temperature variation and the water remained in the work.

### BRIEF DESCRIPTION OF DRAWINGS

FIG. 1 is a block diagram depicting a leak inspection device as a first embodiment.

FIG. 2 is a flowchart of the leak inspection.

FIG. 3 is a table showing a valve sequencing control in the leak inspection.

FIG. 4 is a block diagram depicting a leak inspection device as a second embodiment.

FIG. 5 is a table showing a valve sequencing control in the leak inspection.

FIG. 6 is a block diagram depicting a leak inspection device as a third embodiment.

FIG. 7 is a table showing a valve sequencing control in the leak inspection.

### DESCRIPTION OF EMBODIMENTS

Referring to attached drawings, the embodiments of the present invention are described below.

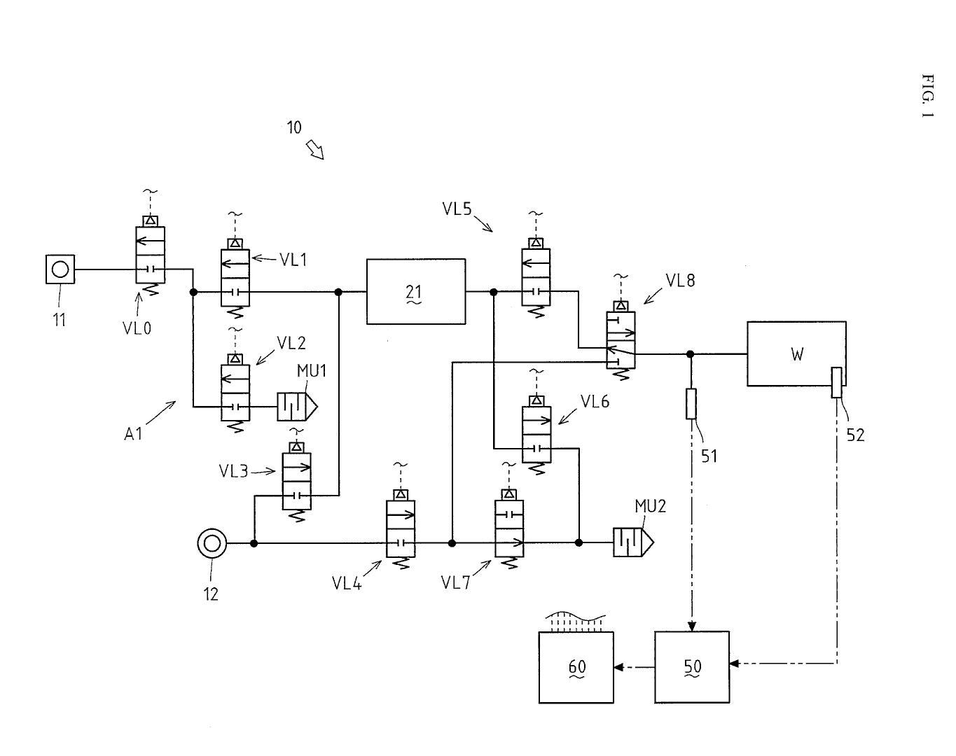

In FIGS. 1, 4 and 6, solid lines represent air pipes of a leak inspection device, broken lines represent air pipes for controlling valves, and two-dot chain lines represent electrical signals.

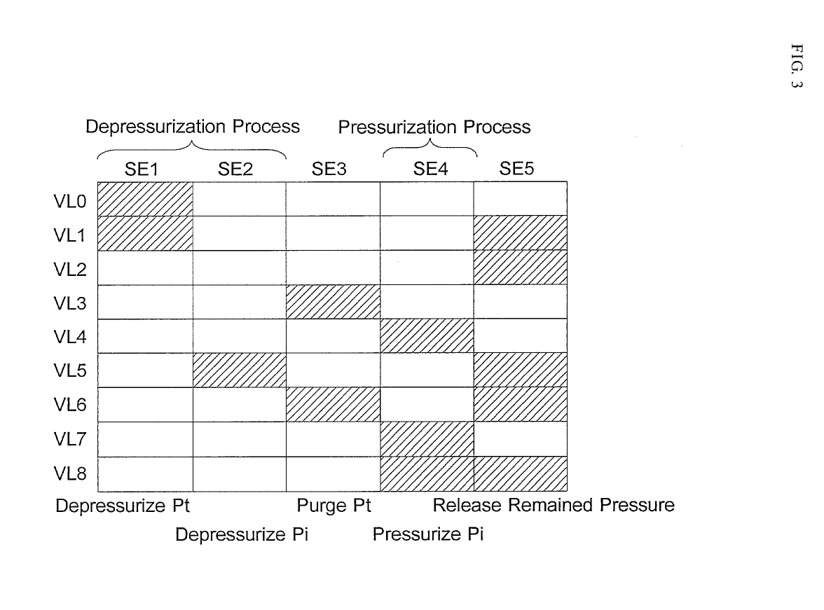

In FIGS. 3, 5 and 7, switching of each valve is shown in each sequence, and hatched areas show “ON” of the valves.

FIG. 1 depicts a leak inspection device 10 as a first embodiment.

The leak inspection device 10 is disposed in an inspection apparatus in an automobile factory. The inspection device 10 includes: sealing a gas inside an engine cylinder block (work W); and removing water remained in the work W and preventing temperature variation of the work W, in which the water remained in the work and the variation in temperature of the work cause disturbances on the inspection. In the embodiment, the gas to be enclosed is a dry air.

The inspection device 10 includes a depressurizing device 11, a pressurizing device 12 and a vacuum tank 21. These components 11, 12 and 21 are connected via air pipes and configure an air pressure circuit Al.

The depressurizing device 11 is a vacuum pump, which is capable of evacuating the air in the circuit Al to create vacuum. The pressurizing device 12 is an air compressor, which pressurizes the circuit Al. The vacuum tank 21 has larger capacity than the work W to be inspected by the inspection device 10, and the depressurizing device 11 evacuates the tank.

The inspection device 10 includes valves VL0 to VL8 and mufflers MU1 and MU2. These valves VL0 to VL8 and mufflers MU1 and MU2 are connected through air pipes and configure the air pressure circuit A1. The valves VL0 to VL8 are two-position spring-return valves and actuated by air pressure in a control circuit 60 as a pilot. The mufflers MU1 and MU2 are communicated with air and capable of opening the circuit A1 and of introducing air into the circuit A1.

The inspection device 10 includes a controller 50, the air pressure control circuit 60, a pressure sensor 51 and a temperature sensor 52. The control circuit 60, the pressure sensor 51 and the temperature sensor 52 are connected to the controller 50.

The controller 50 controls the internal pressure Pi of the work W by using the depressurizing device 11 and the pressurizing device 12. The controller 50 is electrically connected to these devices 11 and 12, and transmits the control signal to control them.

The pressure sensor 51 is disposed in the air pipe near the work W to measure the internal pressure Pi of the work W. The temperature sensor 52 is disposed in the work W to measure the temperature To of the work W. In the embodiment, the temperature sensor 52 is located on the wall of the cylinder. These sensors 51 and 52 transmit the measured values (pressure Pi and temperature To) to the controller 50.

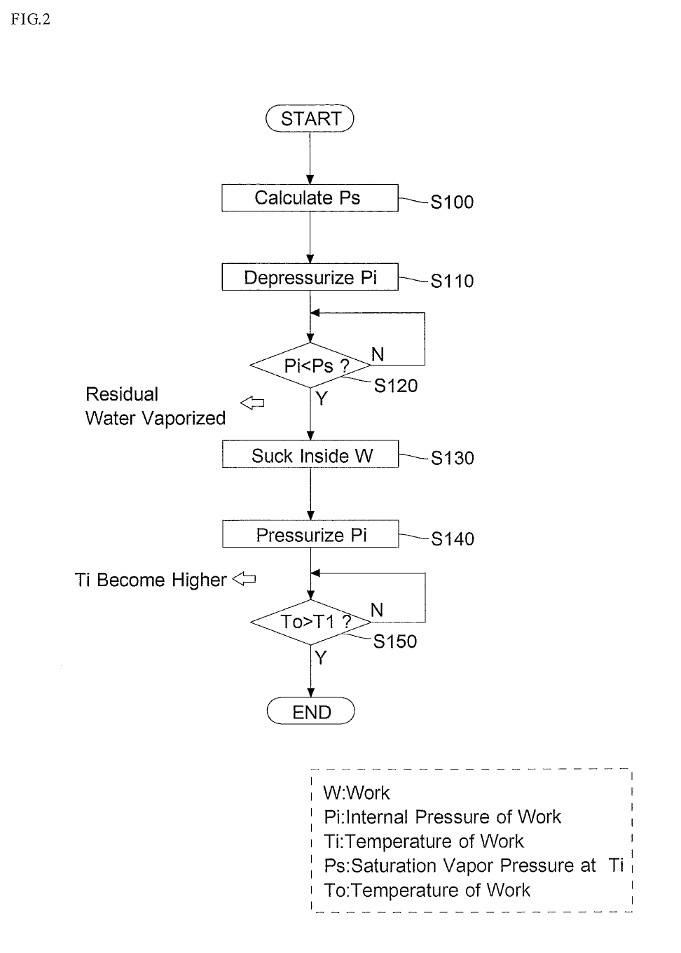

Referring to FIGS. 2 and 3, the leak inspection as a first embodiment is described.

The leak inspection control includes eliminating the disturbances such as residual water inside the work W and changes in temperature of the work W by enclosing gas into the work W before starting the leak inspection.

FIG. 2 depicts an actuator control by the controller 50 for removing the disturbances. FIG. 3 shows valve sequencing of the air pressure circuit Al with the controller 50 during the leak inspection in which the gas is sealed inside the work W.

The controller 50 calculates a saturation vapor pressure Ps in STEP S100. The saturation vapor pressure Ps is calculated assuming that the water temperature T is same as the temperature To of the work W (T=To). The saturation vapor pressure Ps is calculated on the basis of the temperature To measured by the temperature sensor 52 by using the saturation vapor pressure curve stored in the controller 50 in advance.

The controller 50 transmits the control signal to the depressurizing device 11 to vacuum the internal pressure Pi in STEP S 110.

The controller 50 compares the internal pressure Pi detected by the pressure sensor 51 with the saturation vapor pressure Ps in STEP S 120. In STEP S120, if the internal pressure Pi is not smaller than the saturation vapor pressure Ps, depressurizing the internal pressure Pi is continued.

In STEP S120, if the internal pressure Pi is smaller than (reaches) the saturation vapor pressure Ps, the remained water inside the work W is evaporated.

In STEP S130, the controller 50 transmits the control signal to the depressurizing device 11 to vacuum the water vapor.

The controller 50 transmits the control signal to the pressurizing device 12 to pressurize the internal pressure Pi of the work W in STEP S140. The temperature of the gas in the work W is increased by adiabatic compression, whereby the work temperature To is increased according to the rise of internal gas temperature. The controller 50 compares the work temperature To with a predetermined temperature T1 in STEP S150. The predetermined temperature T1 is a temperature being slight higher than the air temperature, which is stored in the controller 50 in advance.

In STEP S150, if the temperature To is not higher than the predetermined temperature T1, the pressurizing of internal pressure Pi is continued. In STEP S150, if the temperature To is higher than (reaches) the predetermined temperature T1, the control of removing the disturbance is finished.

After that, the gas is sealed in the work W, and the leak inspection for inspecting the leak from the work W is started.

Referring to FIG. 3, the valve sequencing control in the air pressure circuit Al with the controller 50 is described below.

In the sequence SE1 as a depressurizing process, the controller 50 turns on the valves VL0 and VL1 (valves VL2 to VL8 are off) to communicate the depressurizing device 11 with the vacuum tank 21, starting the evacuation of the vacuum tank 21. The control 50 controls the valves VL0 to VL8 via the air pressure control circuit 60.

After the depressurization of the vacuum tank 21, in the sequence SE2, the controller 50 turns off the valves VL0 and VL1, and turns on the valve VL5. Thereby, the vacuum tank 21 is communicated with the work W, starting depressurization of the work W by the negative pressure of the vacuum tank 21. The controller 50 detects that the internal pressure Pi of the work W become lower than the saturation vapor pressure Ps (corresponding to STEP S120), moved to the sequence SE3 from the sequence SE2.

In the sequence SE3, the controller 50 turns off the valve VL5, and turns on the valves VL3 and VL6. Thus, the pressurizing device 12, the vacuum tank 21 and the muffler MU2 are communicated with each other, and the tank 21 is purged.

In the sequence SE4 as a pressurizing process, the controller 50 turns off the valves VL3 and VL6, and turns on the valves VL4, VL7 and VL8. Thus, the pressurizing device 12 is communicated with the work W, starting the pressurization of the work W. The work W is heated up by pressurization.

The controller 50 detects that the work temperature To is higher than the predetermined temperature Ti (corresponding to STEP S150), moved to the sequence SE5 from the sequence SE4. In the sequence SE5, the controller 50 turns off the valves VL4 and VL7, and turns on the valves VL1, VL2, VL5 and VL6, maintaining the valve VL8 on. Thus, the vacuum tank 21 is communicated with the muffler MU1, thereby opening the work W to the atmosphere.

Due to the above-described structure, before starting the leak inspection, the water remained in the work W is sucked as water vapor so that the water is completely removed from the inside of the work W. Also, before the inspection, the temperature of the work W is increased to the predetermined temperature T1, so that the work W can be insulated from the temperature of surroundings. As the result, the leak inspection can be performed without being affected by the environment of the work W or by the temperature variation of the work W.

Consequently, the embodiment provides the leak inspection capable of reliably detecting the leak by means of eliminating the disturbances for the leak inspection, before the leak inspection, such as the temperature variation of the work W or the water remained in the work W.

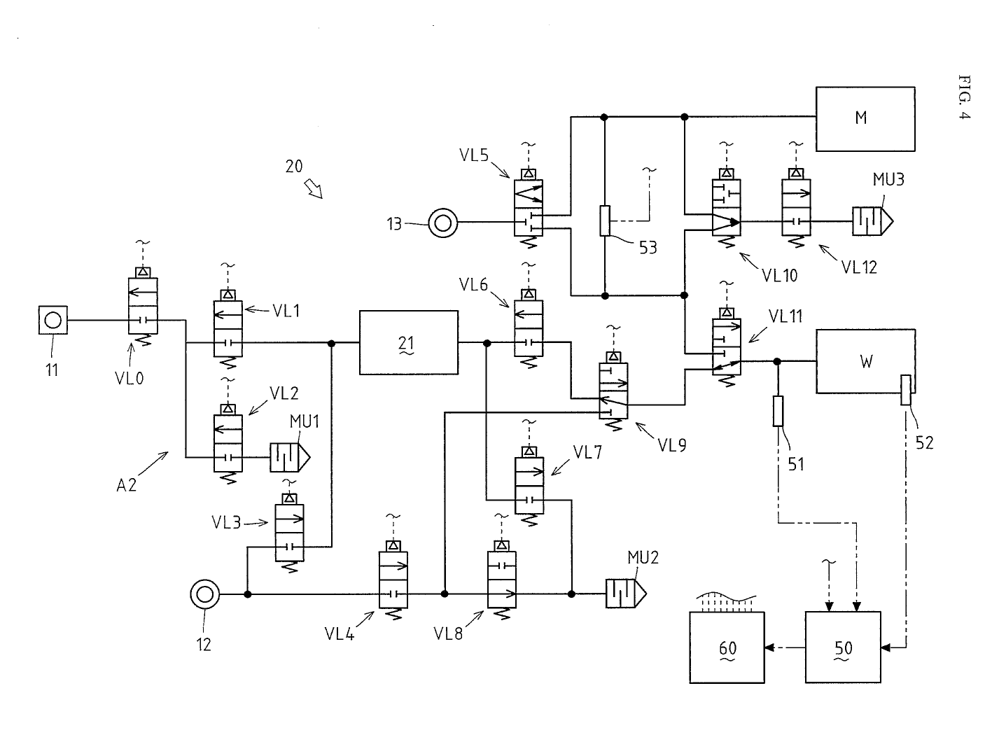

FIG. 4 depicts a leak inspection device 20 as a second embodiment. The leak inspection device 20 is added by the configuration, for a positive air leak test that inspects the leak from the work W into which the gas is enclosed, to the leak inspection device 10 as the first embodiment.

Hereinafter, the same numerals as the first embodiment represent the same structures. The valves VL6 to VL9 in the second embodiment correspond to the valves VL5 to VL8 in the first embodiment, respectively. The valves VL10 to VL12 are added in order to inspect the leak from the work W, i.e., the positive air leak test.

The leak inspection device 20 includes the depressurizing device 11, the pressurizing device 12, a second pressurizing device 13, the vacuum tank 21 and a master chamber M. These components 11, 12, 13, 21 and M are connected via air pipes, and configure the second air pressure circuit A2. The master chamber M has the same capacity as the work W and is a completely sealed chamber.

The inspection device 20 includes the valves VL0 to VL12, the mufflers MU1, MU2 and MU3. These valves VL0 to VL12 and mufflers MU1, MU2 and MU3 are connected through air pipes and configure the air pressure circuit A2.

The inspection device 20 includes the controller 50, the air pressure control circuit 60, the pressure sensor 51, the temperature sensor 52 and a differential pressure sensor 53. The control circuit 60, the pressure sensor 51, the temperature sensor 52 and the differential pressure sensor 53 are connected to the controller 50. The differential pressure sensor 53 is disposed in the air pressure circuit A2, and detects the difference between the pressure of the work W and that of the master chamber M.

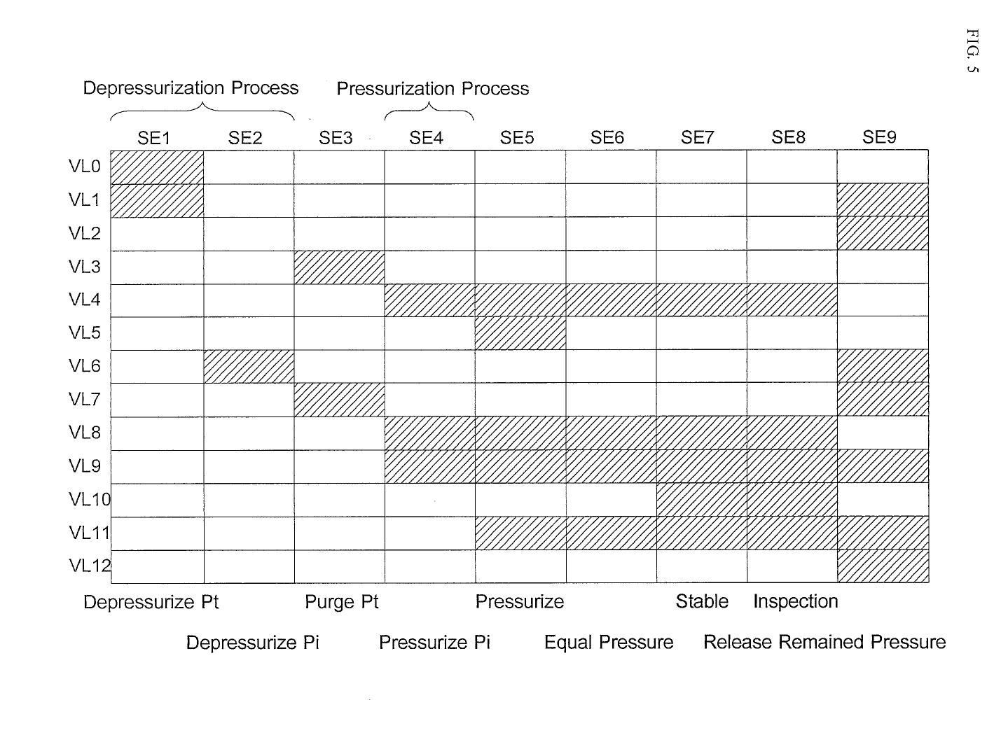

Referring to FIG. 5, the leak inspection as a second embodiment is described.

FIG. 5 shows valve sequencing of the air pressure circuit A2 with the controller 50, in which the actuator control (disturbance Control) by the controller 50 is the same as the first embodiment.

In the second embodiment, the sequences SE1 to SE4 are the same as the first embodiment. The control 50 controls the valves VL0 to VL12 via the air pressure control circuit 60.

In the sequence SES, the controller 50 keeps the valves VL4, VL8 and VL9 on, which are turned on in the sequence SE4, and turns on the valves VL5 and VL11. The pressurizing device 13, the master chamber M and the work W are communicated with each other, and the pressurizing device 13 pressurizes the master chamber M and the work W.

In the sequence SE6, the controller 50 keeps the valves VL4, VL8, VL9 and VL11 on, and turns off the valve VL5. The pressurizing device 13 is insulated from the master chamber M and the work W, thereby making the master chamber M and the work W equal pressure.

In the sequence SE7, the controller 50 keeps the valves VL4, VL8, VL9 and VL11 on, and turns on the valve VL10. Thus, the master chamber M is isolated from the work W, and the master chamber M and the work W are separately stable.

In the sequence SE8 after sequence SE7, the valve sequencing is maintained since the sequence SE7, the controller 50 detects the differential pressure Pd between the master chamber M and the work W that is measured with the differential pressure sensor 53. If the differential pressure Pd is smaller than the predetermined pressure P1, the leak inspection for the work W is clear.

In the sequence SE9, the controller 50 maintains the valves VL9 and VL11 on, and turns on the valves VL1, VL2, VL6, VL7 and VL12. Thereby, the muffler MU3 is communicated with the master chamber M and the work W. The master chamber M and the work W are open to air, so that the remained pressure is released.

Due to the above-described structure, before starting the leak inspection, the water remained in the work W is sucked as water vapor so that the water is completely removed from the inside of the work W. Also, before the inspection, the temperature of the work W is increased to the predetermined temperature T1, so that the work W can be insulated from the temperature of surroundings. As the result, the leak inspection can be performed without being affected by the environment of the work W or by the temperature variation of the work W.

Consequently, the embodiment provides the leak inspection capable of reliably detecting the leak by means of removing the disturbances for the leak inspection, before the leak inspection, such as the temperature variation of the work W or the water remained in the work W. Moreover, the leak inspection is determined by the differential pressure Pd between the work W and the master chamber M, and therefore the minute leak can be detected.

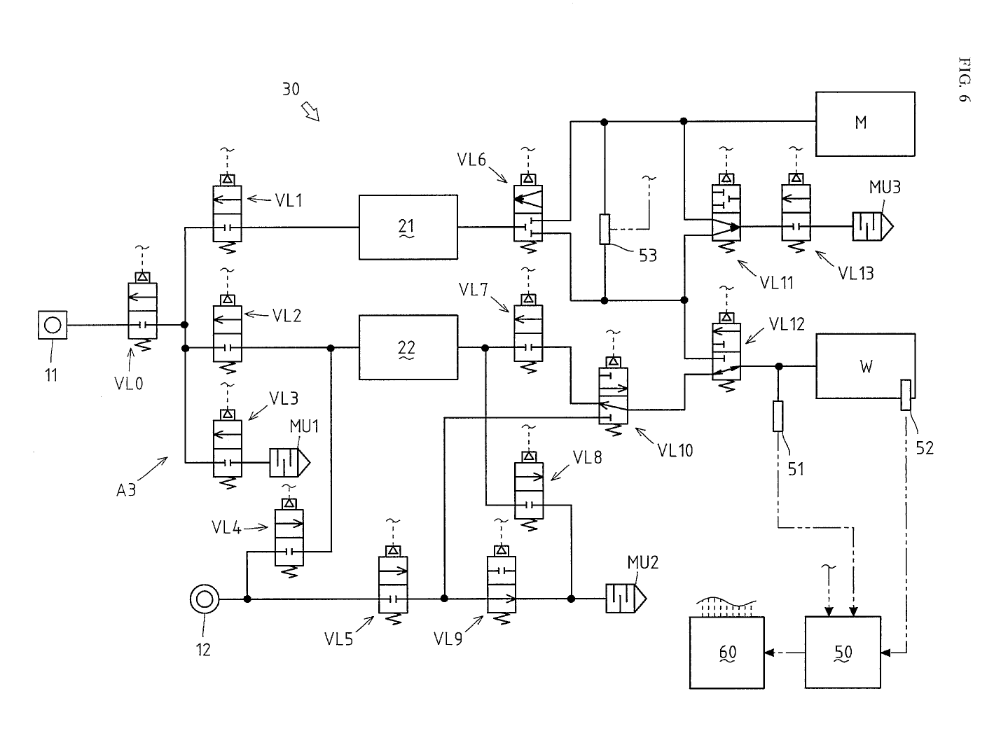

FIG. 6 depicts a leak inspection device 30 as a third embodiment.

The leak inspection device 30 is added by the configuration, for a negative air leak test that inspects the leak from the work W into which the gas is enclosed, to the leak inspection device 10 as the first embodiment. Hereinafter, the same numerals as the first embodiment or the second embodiment represent the same structures.

The valves VL2 to VL5 in the third embodiment correspond to the valves VL1 to VL4 in the first embodiment, and the valves VL7 to VL10 in the third embodiment corresponding to the valves VL5 to VL8 in the first embodiment. The valves VL1, VL6 and VL11 to VL13 are added in order to inspect the leak from the work W, i.e., the negative air leak test. The vacuum tank 22 in the third embodiment corresponds to the vacuum tank 21 in the first embodiment, and the vacuum tank 21 is added in the third embodiment.

The leak inspection device 30 includes the depressurizing device 11, the pressurizing device 12, the vacuum tanks 21, 22 and the master chamber M. These components 11, 12, 21, 22 and M are connected via air pipes, and configure the third air pressure circuit A3.

The inspection device 30 includes the valves VL0 to VL13, the mufflers Min, MU2 and MU3. These valves VL0 to VL13 and mufflers MU1, MU2 and MU3 are connected through air pipes and configure the air pressure circuit A3.

The inspection device 30 includes the controller 50, the air pressure control circuit 60, the pressure sensor 51, the temperature sensor 52 and the differential pressure sensor 53. The control circuit 60, the pressure sensor 51, the temperature sensor 52 and the differential pressure sensor 53 are connected to the controller 50.

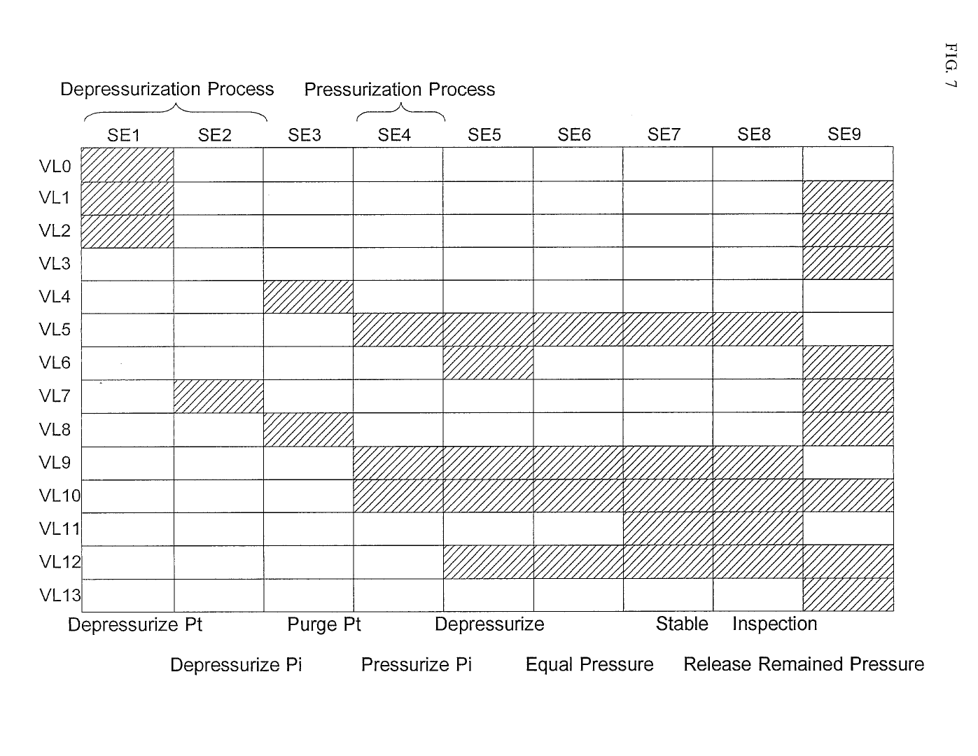

Referring to FIG. 7, the leak inspection as a third embodiment is described. FIG. 7 shows valve sequencing of the air pressure circuit A3 with the controller 50, in which the actuator control (disturbance control) by the controller 50 is the same as the first embodiment.

The control 50 controls the valves VL0 to VL13 via the air pressure control circuit 60. In the sequence SE1 as the depressurization, the valves VL0, VL1, and VL2 are turned on (valves VL3 to VL13 are off). The depressurizing device 11 is communicated with the vacuum tanks 21 and 22, and the vacuum tanks 21 and 22 are evacuated. The sequences SE2 to SE4 in the third embodiment are the same as the sequences SE2 to SE4 in the first embodiment.

In the sequence SES, the controller 50 keeps the valves VL5, VL9 and VL10 on, which are turned on in the sequence SE4, and turns on the valves VL6 and VL12. The vacuum tank 21, the master chamber M and the work W are communicated with each other, and the master chamber M and the work W are depressurized.

In the sequence SE6, the controller 50 keeps the valves VL5, VL9, VL10 and VL12 on, and turns off the valve VL6. The vacuum tank 21 is isolated from the master chamber M and the work W, thereby making the master chamber M and the work W equal pressure.

In the sequence SE7, the controller 50 keeps the valves VL5, VL9, VL10 and VL12 on, and turns on the valve VL11. Thus, the master chamber M is isolated from the work W, and the master chamber M and the work W are separately made stable.

In the sequence SE8 after the sequence SE7, the valve sequencing is maintained since the sequence SE7, the controller 50 detects the differential pressure Pd between the master chamber M and the work W that is measured with the differential pressure sensor 53. If the differential pressure Pd is smaller than the predetermined pressure P1, the leak inspection for the work W is clear.

In the sequence SE9, the controller 50 maintains the valves VL10 and VL12 on, and turns on the valves VL1, VL2, VL3, VL6, VL7, VL8 and VL13. Thereby, the mufflers MU1 and MU3 are communicated with the vacuum tank 21, the master chamber M and the work W. The master chamber M and the work W are open to air so that the remained pressure is released.

Due to the above-described structure, before starting the leak inspection, the water remained in the work W is sucked as water vapor so that the water is completely removed from the inside of the work W. Also, before the inspection, the temperature of the work W is increased to the predetermined temperature Ti, so that the work W can be insulated from the temperature of surroundings. As the result, the leak inspection can be performed without being affected by the environment of the work W or by the temperature variation of the work W.

Consequently, the embodiment provides the leak inspection capable of reliably detecting the leak by means of removing the disturbances for the leak inspection, before the leak inspection, such as the temperature variation of the work W or the water remained in the work W. Moreover, the leak inspection is determined by the differential pressure Pd between the work W and the master chamber M, and therefore the minute leak can be detected.

### DESCRIPTION OF NUMERALS

10: leak inspection device (first embodiment), 20: leak inspection device (second embodiment), 30: leak inspection device (third embodiment), 11: depressurizing device, 12: pressurizing device, 13: pressurizing device, 50: controller, 51: pressure sensor, 52: temperature sensor, 53: differential sensor

1. A device for inspecting a leak from a work comprising:
a depressurizing device for depressurizing a gas in the work;
a pressurizing device for pressurizing the gas in the work;
a temperature sensor for measuring the temperature of the work;
a pressure sensor for measuring the internal pressure of the work; and
a controller for controlling the pressure of the gas in the work by means of the depressurizing device and the pressurizing device, wherein
the controller calculates a saturation vapor pressure at the work temperature measured by the temperature sensor,
the depressurizing device evacuates the gas in the work until the internal pressure of the work reaches the saturation vapor pressure and sucks the vaporized water, and
the pressurizing device pressurizes the gas in the work until the temperature of the work reaches a predetermined temperature.

2. A method for inspecting a leak from a work comprising:
depressurizing process for depressurizing a gas in the work until the internal pressure of the work reaches a saturation vapor pressure at the work temperature and sucking the vaporized water; and
pressurizing process for pressurizing the gas in the work until the temperature of the work reaches a predetermined temperature.
